(19) United States
(12) Patent Application Publication
(10) Pub. No.: US 2026/0279626 A1
(43) Pub. Date: Sep. 17, 2026

(54) R-T-B SINTERED MAGNET

(71) Applicant: PROTERIAL, LTD., Tokyo (JP)

(72) Inventors: Yasutaka SHIGEMOTO, Tokyo (JP); Futoshi KUNIYOSHI, Tokyo (JP); Kouta SAITOU, Tokyo (JP)

(21) Appl. No.: 19/168,990

(22) PCT Filed: Mar. 14, 2024
(86) PCT No.: PCT/JP2024/010079

§ 371 Date: Sep. 25, 2025

(30) Foreign Application Priority Data
Mar. 30, 2023 (JP) 2023-054748
Mar. 30, 2023 (JP) 2023-054749

(51) Int. Cl. H01F 1/057; C22C 38/00; H01F 7/02

(52) U.S. Cl. CPC H01F 1/0577; C22C 38/002; C22C 38/005; H01F 7/0242

(57) ABSTRACT

This R-T-B sintered magnet has a main phase that comprises multiple R₂T₁₄B compound particles, and a grain boundary phase that is located between multiple R₂T₁₄B compound particles and that includes a two-particle grain boundary and grain boundary triple junctions. In a frequency histogram of grain boundary width measured from N reference points included in the two-particle grain boundary in a cross section which includes the orientation direction of the R-T-B sintered magnet in the plane thereof, when class intervals are determined so that the sixth lowest class represents the mode, the total frequency of three classes, i.e., the first, second, and third lowest classes, is not more than 12% of the whole.

### TECHNICAL FIELD

The present invention relates to a sintered R-T-B based magnet.

### BACKGROUND ART

Sintered R-T-B based magnets (where R is at least one of rare-earth elements; T is Fe or Fe and Co; and B is boron) are known as permanent magnets with the highest performance. Therefore, the sintered R-T-B based magnets are used in various types of motors including motors for electric vehicles (EV, HV, PHV, etc.), motors for industrial equipment, and the like; in consumer electronics; and the like. A sintered R-T-B based magnet includes a main phase mainly formed of an R₂T₁₄B compound and a grain boundary phase (hereinafter, may be referred to simply as a “grain boundary”) that is at the grain boundaries of the main phase. The R₂T₁₄B compound is a ferromagnetic phase having high magnetization.

Such sintered R-T-B based magnets have a problem in that coercivity H_{cJ} (hereinafter, may be referred to simply as “coercivity” or “H_{cJ}”) thereof decreases at high temperatures, thus causing an irreversible thermal demagnetization. For this reason, sintered R-T-B based magnets for use in motors for electric vehicles, in particular, are required to have high H_{cJ} even at high temperatures.

It is known regarding the sintered R-T-B based magnets that in the case where a light rare-earth element (mainly, Nd and/or Pr) contained in R of an R₂T₁₄B compound is partially replaced with a heavy rare-earth element (mainly, Dy and/or Tb), the H_{cJ} is improved. As the amount of replacement with the heavy rare-earth element is increased, the He is improved.

However, in the case where a light rare-earth element in the R₂T₁₄B compound is replaced with a heavy rare-earth element, remanence Bᵣ (hereinafter, may be referred to simply as “Bᵣ”) of a sintered R-T-B based magnet is decreased although the H_{cJ} thereof is improved. The heavy rare-earth elements, especially, Dy and the like, exist in small amounts as resources and are produced in limited areas, and for these and other reasons, involve problems of not being supplied stably and of being significantly fluctuated in costs. Therefore, users recently demand that the H_{cJ} should be improved using minimum possible amounts of the heavy rare-earth elements.

Patent Document No. 1 discloses a sintered R-T-B based rare-earth magnet having improved coercivity while having a decreased content of Dy. The composition of this sintered magnet contains B in an amount that is limited in a specific range smaller than that of an R-T-B based alloy generally used conventionally, and contains at least one metal element M selected from Al, Ga and Cu. As a result, an R₂T₁₇ phase is generated at the grain boundary. A transition metal-rich phase (R₆T₁₃M phase) formed from the R₂T₁₇ phase at the grain boundary has a volumetric ratio increased, and this improves the H_{cJ}.

In order to realize a sintered R-T-B based magnet having a decreased content of a heavy rare-earth element while having high Bᵣ and high H_{cJ}, studies have been made on a technology to control an intergranular grain boundary to be thick.

Patent Document No. 2 describes an example of method for measuring the thickness of the intergranular grain boundary.

### CITATION LIST

### Patent Literature

Patent Document No. 1: International Publication WO2013/008756
Patent Document No. 2: Japanese Laid-Open Patent Publication No. 2019-SUMMARY OF INVENTION

### Technical Problem

The thickness of an intergranular grain boundary in a sintered R-T-B based magnet is not uniform but varies in accordance with the position. It has been found out by studies made by the present inventors that the distribution of the thickness of the intergranular grain boundary varies in accordance with conditions of heat treatment and element diffusion during steps of producing the sintered R-T-B based magnet and that the quality of magnet products may be improved by controlling the thickness distribution of the intergranular grain boundary.

An embodiment of the present disclosure provides a sintered R-T-B based magnet having a thickness distribution, of an intergranular grain boundary, that may exhibit superb magnetic characteristics.

### Solution to Problem

A sintered R-T-B based magnet according to the present disclosure provides solutions defined in the following items.

### [Item 1]

A sintered R-T-B based magnet (R is at least one of rare-earth elements and contains at least one of Nd and Pr with no exception, T is Fe or Fe and Co, and B is boron), comprising:
a main phase formed of a plurality of R₂T₁₄B compound grains; and
a grain boundary phase located between the plurality of R₂T₁₄B compound grains and including an intergranular grain boundary and a grain boundary triple junction,
wherein in a frequency histogram of a grain boundary width measured from N-piece reference points included in the intergranular grain boundary that is located in a cross-section including, in a plane thereof, an alignment direction of the sintered R-T-B based magnet, in the case where widths of classes are determined such that the sixth class counted from the lowest class shows the mode, three classes that are the lowest class, the second lowest class and the third lowest class have a total frequency that is not higher than 12% of the frequency of all classes.

### [Item 2]

The sintered R-T-B based magnet of item 1, wherein the cross-section is at a position having a distance from a surface of the sintered R-T-B based magnet that is not shorter than 0.05 mm and not longer than 0.15 mm.

### [Item 3]

The sintered R-T-B based magnet of item 1 or 2, wherein where T has a composition ratio of [T] represented with mass % and B has a composition ratio of [B] represented with mass %, the expression that [T]/55.85>14×[B]/10.8 holds.

### [Item 4]

The sintered R-T-B based magnet of any one of items 1 through 3, wherein the three classes that are the lowest class, the second lowest class and the third lowest class in the frequency histogram have a total frequency that is not higher than 10% of the frequency of all the classes.

### [Item 5]

The sintered R-T-B based magnet of any one of items 1 through 4, wherein the three classes that are the lowest class, the second lowest class and the third lowest class in the frequency histogram have a total frequency that is not lower than 3% of the frequency of all the classes.

### [Item 6]

The sintered R-T-B based magnet of any one of items 1 through 5, wherein R in the sintered R-T-B based magnet has a composition ratio that is not higher than 31 mass %.

### [Item 7]

The sintered R-T-B based magnet of any one of items 1 through 6, wherein Dy and Tb in the sintered R-T-B based magnet have a total composition ratio that is not higher than 0.5 mass % (including 0 mass %).

### [Item 8]

The sintered R-T-B based magnet of any one of items 1 through 7, wherein the sintered R-T-B based magnet includes a portion where a concentration of R gradually decreases from a surface of the magnet toward an interior thereof.

### [Item 9]

The sintered R-T-B based magnet of any one of items 1 through 8, wherein the frequency at which the grain boundary width in the frequency histogram is not longer than 0.03 μm is not higher than 12% of the frequency of all the classes.

### [Item 10]

A sintered R-T-B based magnet (R is at least one of rare-earth elements and contains at least one of Nd and Pr with no exception, T is Fe or Fe and Co, and B is boron), comprising:
a main phase formed of a plurality of R₂T₁₄B compound grains; and
a grain boundary phase located between the plurality of R₂T₁₄B compound grains and including an intergranular grain boundary and a grain boundary triple junction,
wherein in a frequency histogram of a grain boundary width measured from N-piece reference points included in the intergranular grain boundary that is located in a cross-section including, in a plane thereof, an alignment direction of the sintered R-T-B based magnet, the frequency at which the grain boundary width is not longer than 0.03 μm is not higher than 12% of the frequency of all classes.

### [Item 11]

The sintered R-T-B based magnet of item 10, wherein the cross-section is at a position having a distance from a surface of the sintered R-T-B based magnet that is not shorter than 0.05 mm and not longer than 0.15 mm.

### [Item 12]

The sintered R-T-B based magnet of item 10 or 11, wherein where T has a composition ratio of [T] represented with mass % and B has a composition ratio of [B] represented with mass %, the expression that [T]/55.85>14×[B]/10.8 holds.

### [Item 13]

The sintered R-T-B based magnet of any one of items 10 through 12, wherein the frequency at which the grain boundary width in the frequency histogram is in a range that is not shorter than 0.02 μm and not longer than 0.03 μm is not higher than 5% of the frequency of all the classes.

### [Item 14]

The sintered R-T-B based magnet of any one of items 10 through 13, wherein the frequency at which the grain boundary width in the frequency histogram is in a range that is not shorter than 0.02 μm and not longer than 0.03 μm is not lower than 0.5% and not higher than 5% of the frequency of all the classes.

### [Item 15]

The sintered R-T-B based magnet of any one of items 10 through 14, wherein the frequency at which the grain boundary width in the frequency histogram is not longer than 0.03 μm is not lower than 3% and not higher than 12%.

### [Item 16]

The sintered R-T-B based magnet of any one of items 10 through 15, wherein R in the sintered R-T-B based magnet has a composition ratio that is not higher than 31 mass %.

### [Item 17]

The sintered R-T-B based magnet of any one of items 10 through 16, wherein Dy and Tb in the sintered R-T-B based magnet have a total composition ratio that is not higher than 0.5 mass % (including 0 mass %).

### [Item 18]

The sintered R-T-B based magnet of any one of items 10 through 17, wherein the sintered R-T-B based magnet includes a portion where a concentration of R gradually decreases from a surface of the magnet toward an interior thereof.

### [Item 19]

The sintered R-T-B based magnet of any one of items 10 through 18, wherein in the case where widths of classes are determined such that the sixth class counted from the lowest class shows the mode in the frequency histogram, three classes that are the lowest class, the second lowest class and the third lowest class have a total frequency that is not higher than 12% of the frequency of all the classes.

### Advantageous Effects of Invention

According to embodiments of the present disclosure, a sintered R-T-B based magnet having a thickness distribution, of an intergranular grain boundary, that may exhibit superb magnetic characteristics may be provided.

### BRIEF DESCRIPTION OF DRAWINGS

FIG. 1A is a schematic view showing a main phase and a grain boundary phase of a sintered R-T-B based magnet.

FIG. 1B is an enlarged schematic view of the rectangular region enclosed by the dashed line in FIG. 1A.

FIG. 2 is a flowchart showing an example of method for measuring the distribution of the thickness of an intergranular grain boundary (grain boundary width) in a cross-section of a sintered R-T-B based magnet in an embodiment of the present disclosure.

FIG. 3A shows an example of digital image of a backscattered electron image acquired from a cross-section of a sintered R-T-B based magnet.

FIG. 3B shows a binary image of the digital image in FIG. 3A.

FIG. 4A is a partial enlarged view of the digital image in FIG. 3A.

FIG. 4B shows a binary image of the digital image in FIG. 4A.

FIG. 4C shows a thinned image of a grain boundary generated from a binary image of a grain boundary phase.

FIG. 4D shows an example of thinned image of an intergranular grain boundary.

FIG. 4E shows an example of reference points superimposed on a pre-binarization digital image.

FIG. 4F is a partial enlarged view of FIG. 4E.

FIG. 4G shows an example of direction (arrow) in which the grain boundary width is to be measured from a reference point (reference pixel) of interest.

FIG. 4H shows measurement directions extending from the plurality of reference pixels.

FIG. 5 is a semilog graph showing the relationship between the luminance value of each of pixels represented by a numerical value among 0 to 255 and the number of pixels showing each such luminance value.

FIG. 6 shows an optional position Q on a digital image and the luminance values of four pixels enclosing the position Q.

FIG. 7 shows a frequency histogram on a backscattered electron image obtained from a cross-section of each of examples and comparative examples of the sintered R-T-B based magnet, the frequency histogram showing the relationship between the measurement value and the measurement frequency (frequency of measurement or number of data pieces) of the grain boundary width obtained by measurement performed on the grain boundary width at a plurality of positions in an intergranular grain boundary.

FIG. 8 is a graph showing the relationship between the C₁₋₃ total frequency and the H_{cJ} in a frequency histogram obtained from the examples and the comparative examples of the present disclosure.

FIG. 9 is a graph showing the relationship between the frequency of class C3 (in which the grain boundary width is in the range that is not shorter than 0.02 μm and not longer than 0.03 μm; C3 frequency) and the H_{cJ} in the frequency histogram obtained from the examples and the comparative examples of the present disclosure.

### DESCRIPTION OF EMBODIMENTS

The following is conventionally known regarding a sintered R-T-B based magnet: in the case where, for example, (1) R (at least one of rare-earth elements and contains at least one of Nd and Pr with no exception) is contained at a content that is not lower than 27 mass % and not higher than 34 mass % of the entirety of the sintered R-T-B based magnet and (2) T is Fe or Fe and Co and contains Fe with no exception, and Fe is contained at a content that is not lower than 80 mass % with respect to the entirety of T, (3) when the molar ratio of T with respect to B ([T]/[B]) is higher than 14.0 and not higher than 15.0, it is possible to thicken the intergranular grain boundary to improve the H_{cJ} by incorporating an element of Ga or the like.

The molar ratio of T with respect to B ([T]/[B]) is found as follows. An analysis value (mass %) of the concentration of each of elements contained in T (Fe; or at least one of Co, Al, Mn and Si, and Fe) is divided by an atomic weight of the respective element, and the resultant values are added together to find a molar number (a). An analysis value of the concentration of B (mass %) is divided by the atomic weight of B to find a molar number (b). The molar ratio of T with respect to B is a ratio of molar number (a) with respect to molar number (b) (i.e., a/b).

A ratio of T with respect to B ([T]/[B]) that is higher than 14.0 indicates that B is contained at a content that is lower than the stoichiometric ratio of the R₂T₁₄B compound. In this case, in the sintered R-T-B based magnet, the amount of B used to form the main phase (R₂T₁₄B compound) is smaller than the amount of T used to form the main phase (R₂T₁₄B compound).

Next, a fundamental microstructure of a sintered R-T-B based magnet will be described.

The sintered R-T-B based magnet has a microstructure in which powder particles of a raw material alloy are bound together through sintering, and includes a main phase mainly formed of an R₂T₁₄B compound and a grain boundary phase that is at the grain boundaries of the main phase.

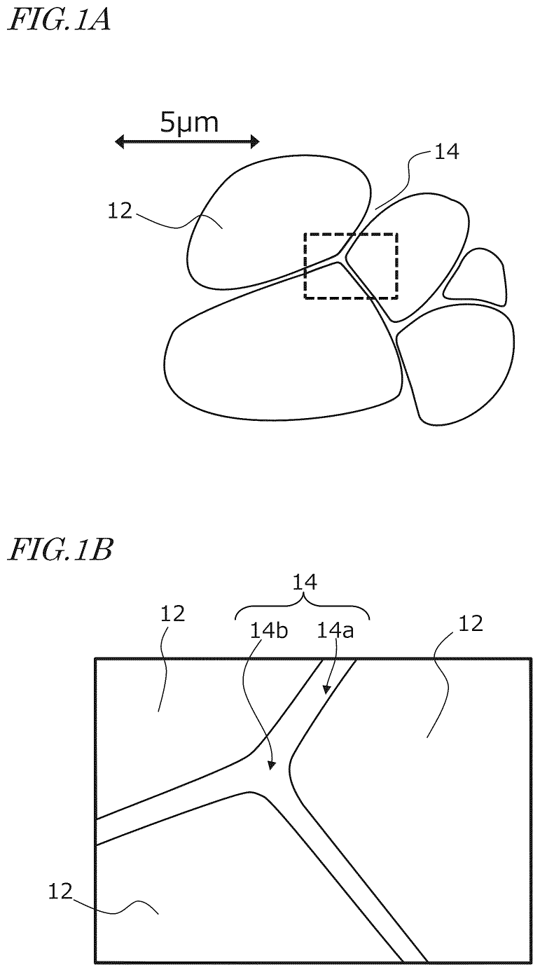

FIG. 1A is a schematic view showing a main phase and a grain boundary phase of a sintered R-T-B based magnet. FIG. 1B is an enlarged schematic view of the rectangular region enclosed by the dashed line in FIG. 1A. In FIG. 1A, an arrow indicating a length of 5 μm is shown as an example of reference length to represent size. As shown in FIG. 1A and FIG. 1B, the sintered R-T-B based magnet includes a main phase 12 mainly formed of an R₂T₁₄B compound and a grain boundary phase 14 at the grain boundaries of the main phase 12. As shown in FIG. 1B, the grain boundary phase 14 includes an intergranular grain boundary phase 14a, along which two R₂T₁₄B compound grains adjoin each other, and a grain boundary triple junction 14b, around which three or more R₂T₁₄B compound grains are present.

The R₂T₁₄B compound, which forms the main phase 12, is a ferromagnetic phase having high saturation magnetization and an anisotropy field. Therefore, in the sintered R-T-B based magnet, it is possible to improve the Bᵣ by increasing the abundance ratio of the R₂T₁₄B compound, which forms the main phase 12. In order to increase the abundance ratio of the R₂T₁₄B compound, an amount of R, an amount of T and an amount of B in the raw material alloy may be brought closer to the stoichiometric ratio of the R₂T₁₄B compound (i.e., amount of R:amount of T:amount of B=2:14:1). In general, in the case where the amount of B or the amount of R to form the R₂T₁₄B compound is lower than the stoichiometric ratio, a soft magnetic phase such as an Fe phase, an R₂T₁₇ phase or the like is generated in the grain boundary phase 14, and the H_{cJ} drastically decreases. However, in the case where the amount of B is made smaller than the stoichiometric ratio of the R₂T₁₄B compound and at least one metal element M selected from Al, Ga and Cu is incorporated, a transition metal-rich phase (e.g., an R-T-Ga phase) is generated at the grain boundaries, instead of the R₂T₁₇ phase, and also the intergranular grain boundary is thickened. As a result, high H_{cJ} may be obtained.

As described above, regarding the sintered R-T-B based magnet, the thickness of the intergranular grain boundary is not uniform but varies in accordance with the position even in one, same field of view obtained by, for example, observation with a scanning electron microscope (SEM). The thickness of the intergranular grain boundary may have different values at different positions of measurement. The measurement values of the thickness of the intergranular grain boundary obtained by measurement performed at a great number of positions are dispersed around an average value. It has been found out by studies made by the present inventors that sintered R-T-B based magnets having the same average value of the thickness of the intergranular grain boundary have different coercivity H_{cJ} in accordance with the manner of distribution of the thickness.

First, an example of method for finding the distribution of the thickness of the intergranular grain boundary of a sintered R-T-B based magnet will be described. In the present disclosure, the “thickness of the intergranular grain boundary” is a value measured for a cross-section including, in a plane thereof, an alignment direction of the sintered R-T-B based magnet (that is, the cross-section for the measurement is not vertical to the alignment direction). Therefore, the “thickness” of the intergranular grain boundary expanding three-dimensionally has the same meaning as that of the “width” of the intergranular grain boundary appearing in such a cross-section. For this reason, hereinafter, the “thickness of the intergranular grain boundary” may be referred to as a “grain boundary width” for the sake of simplicity. The “alignment direction” of the sintered R-T-B based magnet is generally parallel to the axis of easy magnetization (direction of easy magnetization) of the main phase crystal aligned in the magnetic field. The axis of easy magnetization of the R₂T₁₄B compound generally matches the “c axis” of this crystal. Therefore, the “alignment direction” of the sintered R-T-B based magnet is determined as one direction in which the orientations of the c-axis of the main phase crystal grains are most aligned.

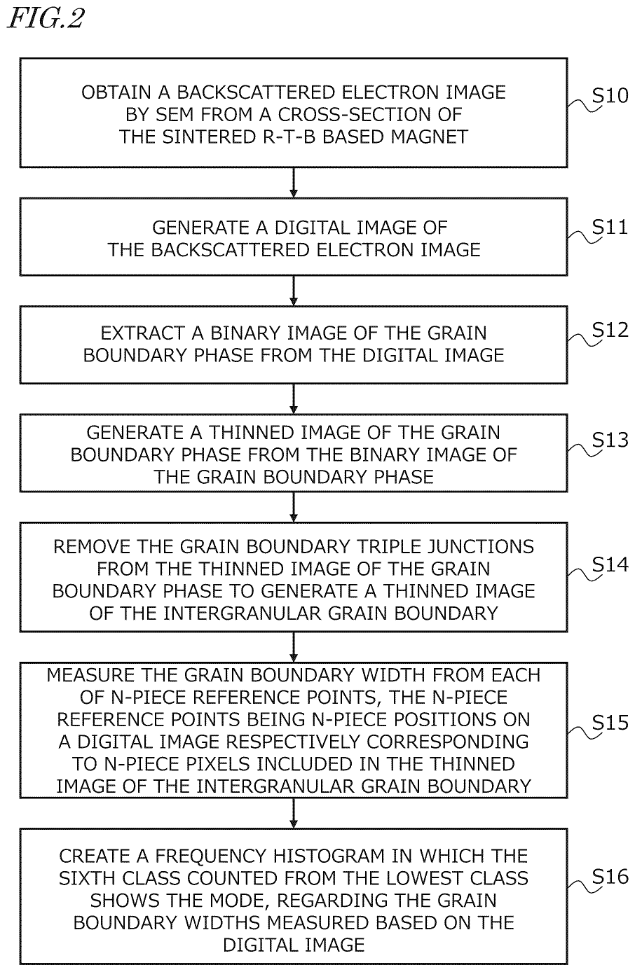

With reference to the flowchart in FIG. 2, an example of method for measuring the distribution of the grain boundary width will be described in detail.

First, a sintered R-T-B based magnet is prepared. R is at least one of rare-earth elements and contains at least one of Nd and Pr with no exception. T is Fe or Fe and Co. B is boron. As described above, the sintered R-T-B based magnet includes a main phase formed of a plurality of R₂T₁₄B compound grains and a grain boundary phase that is between the plurality of R₂T₁₄B compound grains and includes an intergranular grain boundary and a grain boundary triple junction.

Next, in step S10 in FIG. 2, a backscattered electron (BSE) image by a scanning electron microscope (SEM) is obtained from a cross-section of the sintered R-T-B based magnet. As the conditions for image capturing with the SEM, for example, the magnification ratio is set such that each of pixels has the size of about 0.005 to about 0.02 μm. Typically, the observation magnification ratio is 3000× to 10000×, the acceleration voltage of the electron beam is 1 to 5 kV, and the current value thereof is 15 to 20 μA. In order to obtain data of a higher precision, it is desirable to use a field emission scanning electron microscope (FE-SEM). The range of compositions of, and the production method for, the sintered R-T-B based magnet in this embodiment will be described below. The cross-section of the sintered R-T-B based magnet includes, in a plane thereof, the alignment direction of the sintered R-T-B based magnet.

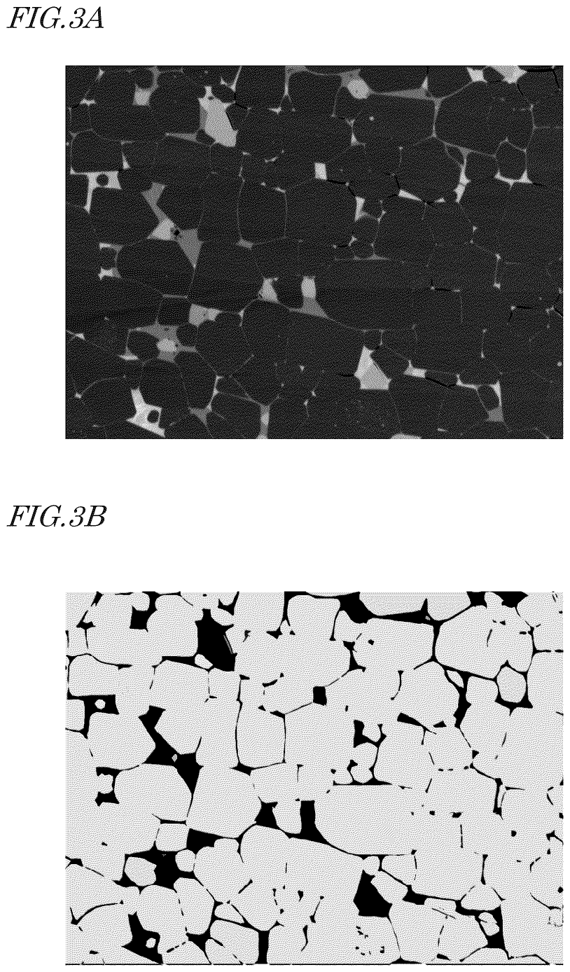

In step S11, digital data (gray scale) of the backscattered electron image is generated. FIG. 3A shows the digital data put into an image. In the digital image in FIG. 3A, the main phase is shown with pixels having relatively low luminance values, and is observed as a black region. By contrast, the grain boundary phase is shown with pixels having relatively high luminance values, and is observed as a gray or while region. The luminance value becomes higher as the signal strength of the backscattered electron becomes higher. The signal strength of the backscattered electron becomes higher as the concentration of an element having a large atomic number Z becomes higher. In an 8-bit gray scale image, the luminance value of each of pixels is represented with 256 scales that are not smaller than 0 and not larger than 255.

In an embodiment of the present disclosure, a plane for which a digital image of the backscattered electron image is captured is at a position having a depth that is not shallower than 0.05 mm and not deeper than 0.15 mm from the surface of the magnet. The plane for which the digital image is to be captured may be produced by use of a known processing device and a known processing method as follows, for example. A sample is cut by a peripheral blade cutter such that the cross-section includes, in a plane thereof, the alignment direction; the cross-section is smoothed appropriately by use of sandpaper; and a cross-section polisher is used in a final step to produce a smooth and clean sample cross-section with no processing distortion or dents. An area size of each digital image (captured area) is preferably not smaller than 100 μm², and more preferably not smaller than 400 μm². For example, a region having a size of 20 μm or longer in the horizontal direction and 20 μm or longer in the vertical direction may be captured. It is preferred that a plurality of digital images are obtained from one sintered R-T-B based magnet such that a total area of the digital images is not smaller than 3000 μm². The plurality of digital images are obtained by capturing digital images at random or by capturing a series of digital images continuously such that one cross-section is formed of such a series of digital images.

Next, in step S12 in FIG. 2, a binary image of the main phase and the grain boundary phase is extracted from the digital image. Specifically, the digital image in FIG. 3A is binarized to generate a binary image shown in FIG. 3B. In this example, among a great number of pixels included in the digital image, black pixels are used to show the grain boundary phase, and pixels having a relatively high luminance value (in the figure, gray pixels, but typically, “white” pixels) are used to show the main phase. More specifically, when a digital image binarized from a backscattered electron image is to be generated, the pixels included in the pre-binarization image are classified into either the “grain binary phase” and the “main phase” in accordance with the level of the luminance value. Whether or not one pixel is classified into the “grain boundary phase” is determined based on whether or not the luminance value of the pixel is higher than a predetermined threshold value. As described below, a pixel having an intermediate luminance value in the pre-binarization digital image may be classified into the “grain boundary phase” or the “main phase” in the binary image, in accordance with the level of the threshold value. This shows a possibility that the shape and the size of the grain boundary phase in the binary image are changed in accordance with the level of the threshold value. However, in an embodiment of the present disclosure, the binary image is used to generate a thinned image of the intergranular grain boundary, and the measurement of the grain boundary width is performed based on the pre-binarization gray scale image. Therefore, it is suppressed that the measurement value of the grain boundary width significantly changes in accordance with the level of the threshold value.

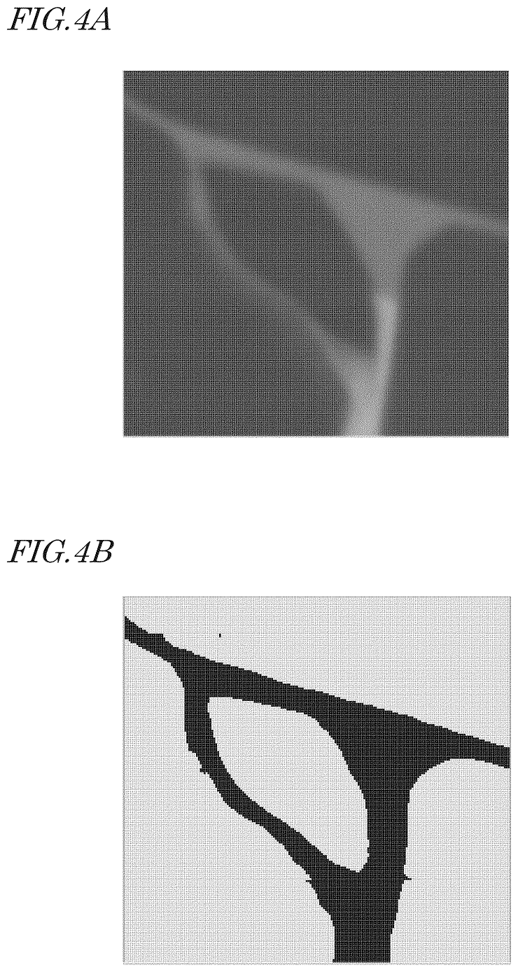

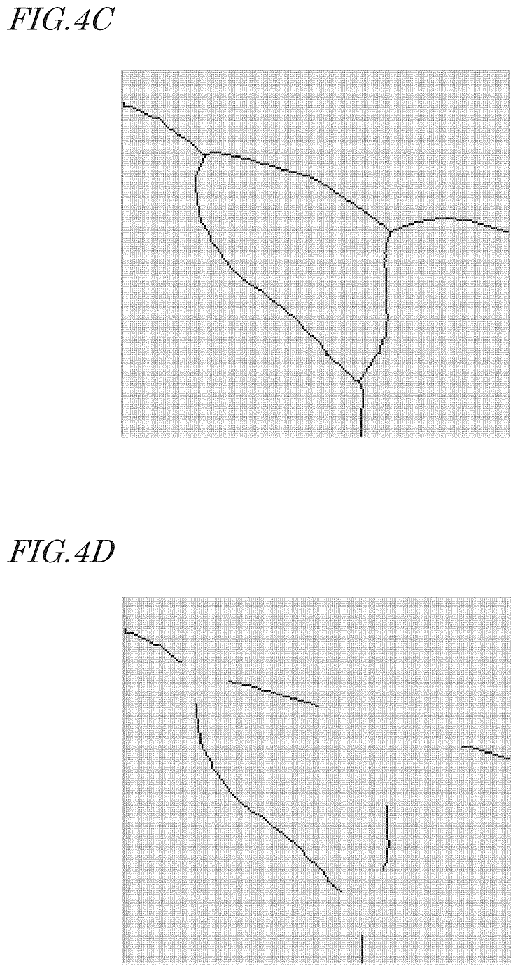

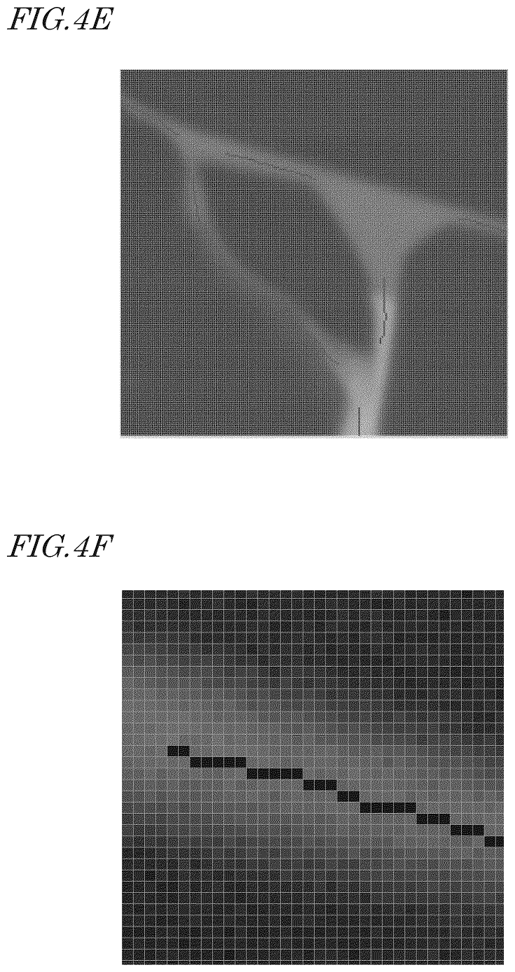

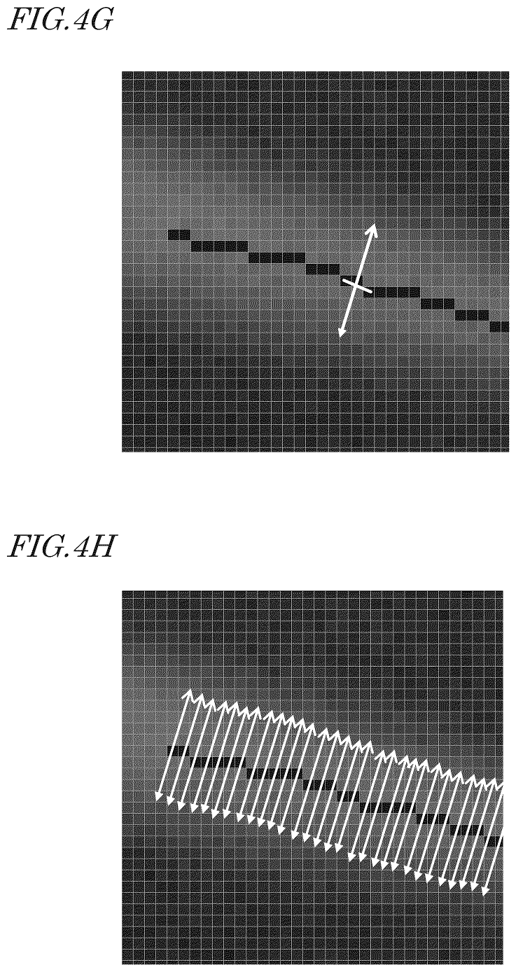

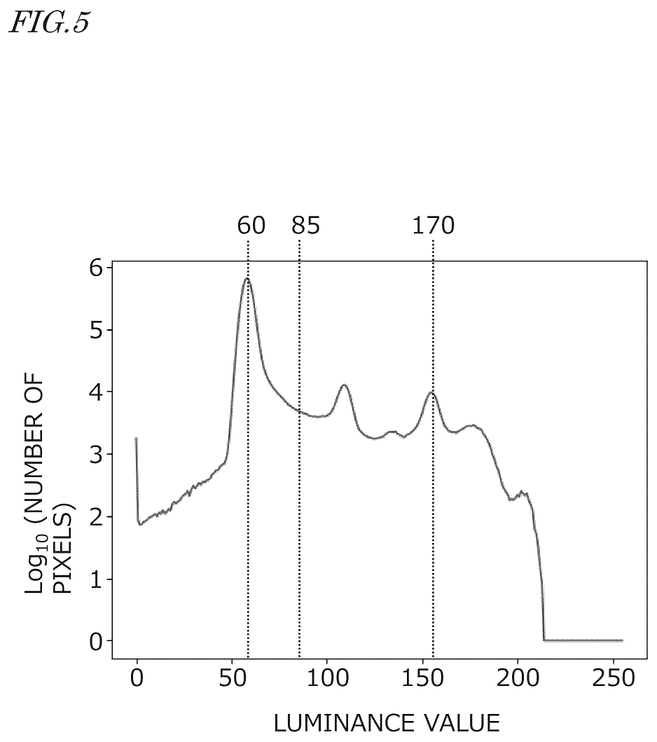

FIG. 4A is a partial enlarged view of the digital image (gray scale image) in FIG. 3A. Hereinafter, the enlarged region will be described. The following process is performed on images (five images) each having a size of, for example, about 10 μm×about 10 μm selected from a digital image corresponding to a field of view having a size of, for example, 28 μm×21 μm in the cross-section to be captured.

In the digital image in FIG. 4A, the region having a relatively high luminance value corresponds to the grain boundary phase. FIG. 4B is an image binarized from the digital image in FIG. 4A. A binary image of the grain boundary phase is shown with the black pixels.

In step S13 in FIG. 2, a thinned image of the grain boundary phase is generated from the binary image of the grain boundary phase. The thinning (or skeletonization) is performed by use of any image processing algorithm. FIG. 4C shows an example of the generated “thinned image (skeleton image) of the grain boundary phase”. The line width of the thinned image of the intergranular grain boundary corresponds to 1 pixel. Each of pixels forming such a thinned image is adjacent to at least one of 8 pixels located around such each pixel to form “continuous thin lines”.

In step S14, the grain boundary triple junctions are removed from the thinned image of the grain boundary phase to generate a thinned image of the intergranular grain boundary. FIG. 4D shows an example of the thinned image of the intergranular grain boundary. The technique to remove the grain boundary triple junctions is not limited to any specific technique. For example, the method described in Patent Document No. 2 may be used. The entirety of Japanese Laid-Open Patent Publication No. 2019-015573 is incorporated herein by reference.

In step S15, a grain boundary width is measured from each of N-piece reference points. The N-piece reference points are positions on the pre-binarization digital image respectively corresponding to N-piece pixels (N is, for example, an integer of 10000 or larger) included in the thinned image of the intergranular grain boundary. FIG. 4E shows examples of reference points superimposed on the pre-binarization digital image. FIG. 4F is a partial enlarged view of FIG. 4E. In FIG. 4E, the region in which pixels each having a relatively high luminance value are assembled shows the grain boundary phase. Pixels of a low luminance value that are located at, or in the vicinity of, the center in a direction in which the “width” of the grain boundary phase expands (thickness direction of the grain boundary phase) corresponds to reference points. The reference points are pixels that form the thinned image of the intergranular grain boundary.

In order to measure the grain boundary width from each reference point, it is necessary to estimate the direction in which the grain boundary phase expands toward the main phase located on both of two sides of the grain boundary phase (to estimate the thickness direction of the grain boundary phase). FIG. 4G shows an arrow showing the direction in which the grain boundary width is to be measured from a reference point (reference pixel) of interest. Determined as such a width measurement direction (direction of the bidirectional arrow) is, for example, a direction crossing, perpendicularly, a line segment that connects centers of two pixels adjacent to the reference pixel of interest. In this case, each of the two pixels adjacent to the reference pixel of interest is either one of 8 pixels in the vicinity of the reference pixel. The measurement direction determined in this manner may fluctuate minutely in accordance with the position of the reference pixel. Therefore, a direction averaged for a plurality of reference pixels arranged continuously (e.g., 5 or 7 reference pixels) may be selected as the measurement direction. Referring to FIG. 4G and FIG. 4H, two tips of each of bidirectional arrows are at the border between the grain boundary phase and the main phase. In other words, the length of each of the bidirectional arrows is the “grain boundary width” at the position of the bidirectional arrow (position of the corresponding reference point).

In order to correctly measure the grain boundary width along the measurement direction determined as described above, it is necessary to determine, at a high positional resolution, the position beyond the arrow extending from each reference point shown in FIG. 4H. In the pre-binarization digital image shown in FIG. 4H, the luminance value of each pixel has a value that is, for example, not smaller than 0 and not larger than 255, like in the image in FIG. 3A. As seen from, for example, the image in FIG. 3A, the luminance value of the grain boundary phase is higher than the luminance value of the main phase. An appropriate luminance value at an intermediate position between the luminance value of the grain boundary phase and the luminance value of the main phase may be selected as a reference value for classification, so that pixels each having a luminance value of a reference value or higher are classified into the grain boundary phase.

FIG. 5 is a semilog graph of the digital image (gray scale) shown in, for example FIG. 3A. The semilog graph shows the relationship between the luminance value of each pixel represented by one of 0 to 255 scales and the number of pixels showing each such luminance value. The horizontal axis of the graph represents the luminance value, and the vertical axis of the graph represents the number of pixels shown with the log₁₀ scale. In the example in FIG. 5, the local mode is recognized at or around the luminance values of 60, 110, 130, 170, 180 and the like. The pixels having a luminance value of 60 or in the vicinity thereof are determined as being in the main phase, the pixels having a luminance value of 110 or in the vicinity thereof are determined as being in the R-T-Ga phase, and the pixels having a luminance value of 170 or in the vicinity thereof are determined as being in an oxide phase.

In the case where a digital image (gray scale image) is generated from each of a plurality of backscattered electron image obtained from the cross-section of the sintered R-T-B based magnet, the luminance values in each digital image generally show the distribution shown in FIG. 5. However, the local peak positions of the luminance value may change in accordance with the image capturing conditions. Therefore, in the present disclosure, gamma correction is performed on the pre-binarization digital image for calibration, such that the local peak position (value in the horizontal axis) of the luminance value of the main phase shows the value of 60 and the local peak position (value in the horizontal axis) of the luminance value of the oxide phase in the grain boundary phase shows the value of 170. FIG. 5 shows an example of distribution of the frequency (number of data pieces) of the luminance value in the digital image (pre-binarization) processed by the gamma correction.

In the present disclosure, as an appropriate reference value at an intermediate position between the luminance value of the grain boundary phase and the reference value of the main phase, a luminance value of 85 is adopted for the post-gamma correction gray scale image described above. That is, when the post-gamma correction digital image (gray scale image) is to be binarized, the luminance value of 85 is used as the reference value. Specifically, pixels having a luminance value of 85 or higher are classified into the grain boundary phase, and pixels having a luminance value of smaller than 85 are classified into the main phase.

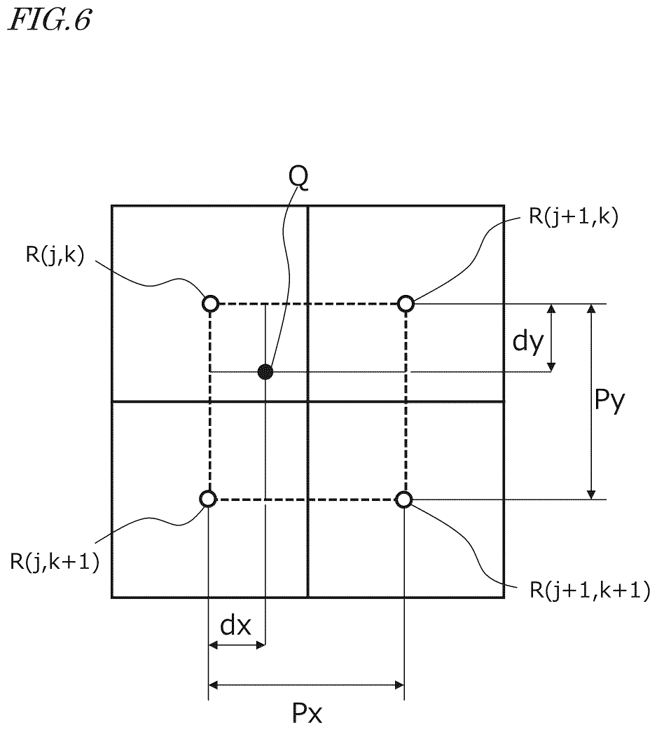

The luminance value is obtained for each pixel from a digital image (gray scale image). Therefore, in the case where one pixel has a size of, for example, 0.01 μm (=10 nm), the resolution of the measurable “grain boundary width” is 0.01 μm. In order to measure the grain boundary width at a high precision, it is preferred that the size of one pixel is made small (e.g., to smaller than 0.01 μm). In the present disclosure, in order to improve the positional resolution regardless of the size of one pixel, linear interpolation is performed. Hereinafter, an example of linear interpolation will be described with reference to FIG. 6.

FIG. 6 shows an optional position Q on a digital image and four pixels having centers thereof enclose the position Q. Specifically, four pixels in total including 2 pixels in the horizontal direction×2 pixels in the vertical direction are shown, and a rectangle connecting the centers of the pixels enclose the position Q. In this embodiment, the positions of the four pixels (central positions of the pixels) are represented as (j, k), (j+1, k), (j, k+1) and (j+1, k+1). The luminance values at the centers of the pixels are represented as R(j, k), R(j+1, k), R(j, k+1) and R(j+1, k+1). Where the size in the horizontal direction and the size in the vertical direction of one pixel are respectively Px and Py, the luminance value at position Q may be approximated by an interpolation technology such as, for example, bilinear interpolation based on R(j, k), R(j+1, k), R(j, k+1) and R(j+1, k+1) and dx/Px and dy/Py, which define the positions of the point Q with respect to the four pixels. Once the luminance value of each pixel is given in this manner, the position at which the luminance value equals 85, that is, the position at the border between the grain boundary phase and the main phase, may be determined without being restricted by the size of the pixels.

When the position at which the luminance value equals 85 (border position) is determined in this manner, the distance from each reference point to the border position along the above-described measurement direction is calculated. Each reference point is sandwiched between two borders. Therefore, the distances from the borders located on both of two sides of the reference point of interest to the reference point are added together, and as a result, the measurement value of one grain boundary width is obtained. It is preferred that the reference points correspond to all the pixels included in the thinned image of the intergranular grain boundary of the grain boundary phase. Alternatively, for example, reference points may be selected at a predetermined interval so as to skip some pixels. It is preferred that the number of the reference points (number N) selected from one digital image is not smaller than 10000.

FIG. 2 is now referred to again. In step S16, regarding the grain boundary widths measured based on the digital image (gray scale image), a frequency histogram in which the sixth class counted from the lowest class shows the mode is created. At this point, the classes are set to have the same width.

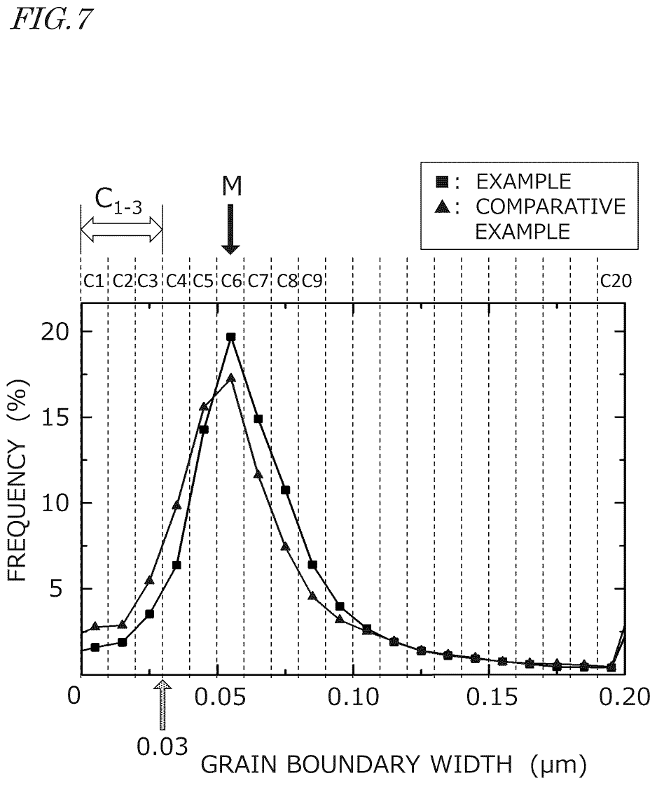

FIG. 7 shows a frequency histogram on a backscattered electron image obtained from a cross-section of each of examples and comparative examples of the sintered R-T-B based magnet. The frequency histogram shows the relationship between the measurement value and the measurement frequency (frequency of measurement or number of data pieces) of the grain boundary width obtained by measurement performed on the grain boundary width at a plurality of positions in the intergranular grain boundary. In FIG. 7, the classes are distinguished by a plurality of dashed lines extending in the vertical direction, and the X'th class counted from the lowest class C1 is labeled as “CX”. The width of each class is the interval between two adjacent dashed lines.

In this frequency histogram, the widths of the classes along the axis of the grain boundary width are determined such that the sixth class C6 counted from the lowest class C1 shows the mode M. In FIG. 7, data in the examples are shown with squares, and data in the comparative examples are shown with triangles. A feature by which the examples are distinguished from the comparative examples is that three classes C1, C2 and C3, which are the first, second and third classes counted from the lowest class C1, have a total frequency that is not higher than 12% of the frequency of all the classes. Hereinafter, the total of these three classes will be represented as “C1-3”. According to the above-described method for measuring the grain boundary width, the total of classes C1-3 is defined by a grain boundary width that is not longer than 0.03 μm (range that is longer than 0 μm and not longer than 0.03 μm). In the case where the grain boundary width is measured in a certain manner, the measurement values of the grain boundary width may have a deviation. However, even in the case where such a deviation occurs, the influence of the deviation is ignorable as long as the widths of the classes are determined such that the sixth class C6 counted from the lowest class C1 show the mode M.

As seen from the examples and the comparative examples described below, in a sintered R-T-B based magnet (examples) in which three classes C1, C2 and C3, which are the first, second and third classes counted from the lowest class C1, have a total frequency (total frequency of C₁₋₃) that is not higher than 12% of the frequency of all the classes, a high H_{cJ} that is not lower than about 1400 kA/m, typically, not lower than about 1500 kA/m, may be achieved. There is a tendency that as the ratio of the total frequency of C₁₋₃ (especially, the frequency of class C3) with respect to the frequency of all the classes is lower, the H_{cJ} is increased. This clarifies the relationship between the thickness distribution of the intergranular grain boundary and the H_{cJ}, and provides a guideline to modify the grain boundary.

Hereinafter, an example of method for producing a sintered R-T-B based magnet in which the total frequency of the three classes C1, C2 and C3 is not higher than 12% of the frequency of all the classes (the frequency at which the grain boundary width is not longer than 0.03 μm is not higher than 12% of the frequency of all the classes) will be described.

### <Sintered R-T-B Based Magnet>

R is a rare-earth element containing Y or Sc, and contains at least one selected from the group consisting of Nd, Pr and Ce with no exception. Preferably, a combination of rare-earth elements represented by Nd—Pr, Nd—Dy, Nd—Tb, Nd—Dy—Tb, Nd—Pr—Dy, Nd—Pr—Tb or Nd—Pr—Dy—Tb is used.

Among the elements of R, Dy and Tb are especially effective to improve the H_{cJ}. R may contain another rare-earth element such as La, Ho or the like in addition to the above-mentioned elements, and mischmetal or didymium may also be used. R does not need to include a highly pure element, and may contain impurities unavoidably incorporated during the production, in an industrially available range. The content of R is, for example, not lower than 27 mass % and not higher than 35 mass %. Preferably, the content of R in the sintered R-T-B based magnet is not higher than 31 mass % (not lower than 27 mass % and not higher than 31 mass %, preferably not lower than 29 mass % and not higher than 31 mass %). R may be contained in the sintered R-T-B based magnet at a content that is not higher than 31 mass % and oxygen may be contained at a content that is not lower than 400 ppm and not higher than 4000 ppm (preferably not lower than 400 ppm and not higher than 2500 ppm, and more preferably not lower than 400 ppm and not higher than 2000 ppm), so that generation of oxidized R is decreased. Therefore, higher magnetic characteristics may be obtained.

T contains iron (encompassing a case where T is substantially formed of iron (Fe)), and at most 50 mass % thereof may be replaced with cobalt (Co) (encompassing a case where T is substantially formed of iron and cobalt). Co is effective to improve the temperature characteristics and the corrosion resistance, and may contain Co at a content that is not higher than 10 mass %. The content of T may occupy the remaining portion other than R and B, or may occupy the remaining portion other than R, B and M described below.

B may be contained at a known content, and a preferred range of content of B is, for example, 0.8 mass % to 1.2 mass %. In the case where the content of B is lower than 0.8 mass %, high H_{cJ} may not be obtained. In the case where the content of B exceeds 1.2 mass %, the Bᵣ may be decreased. B may be partially replaced with C (carbon).

In addition to the above-described elements, an element M may be incorporated in order to improve the H_{cJ}. The element M is at least one selected from the group consisting of Al, Si, Ti, V, Cr, Mn, Ni, Cu, Zn, Ga, Zr, Nb, Mo, In, Sn, Hf, Ta and W. The amount of the element M is preferably not higher than 5.0 mass %. A reason for this is that when the amount of the element M exceeds 5.0 mass %, the Bᵣ may be decreased. Unavoidable impurities may be permitted.

N (nitrogen) is contained in the sintered R-T-B based magnet at a content that is preferably not lower than 50 ppm and not higher than 600 ppm. Pulverization may be performed such that the content of N (nitrogen) is not lower than 50 ppm and not higher than 600 ppm, the ease of pulverization is improved while the decline in the magnetic characteristics due to the nitridation is suppressed. The content of nitrogen is more preferably not lower than 50 ppm and not higher than 400 ppm, and most preferably not lower than 100 ppm and not higher than 300 ppm. A reason for this is that with such a range, the ease of pulverization may be further improved while the decline in the magnetic characteristics due to the nitridation may be suppressed. C (carbon) is contained in the sintered R-T-B based magnet at a content that is preferably not lower than 50 ppm and not higher than 1300 ppm.

An example of composition of the sintered R-T-B based magnet in this embodiment will be described below.

In the case where
R: not lower than 28 mass % and not higher than 35 mass %
B: not lower than 0.8 mass % and not higher than 1.2 mass %, and
T: not lower than 61.5 mass % are contained, and
where the composition ratio of T represented by mass % is [T] and the composition ratio of B represented by mass % is [B],

[T]/55.85>14×[B]/10.8 expression (1) is fulfilled.

Expression 1 may be fulfilled, so that the content of B is lower than that of a general sintered R-T-B based magnet. In a general sintered R-T-B based magnet, [T]/55.85 (atomic weight of Fe) is smaller than 14×[B]/10.8 (atomic weight of B), such that the R₂T₁₇ phase, which is a soft magnetic phase that inhibits improvement in the coercivity, is prevented from being generated in addition to the R₂T₁₄B phase, which is generated as the main phase.

### <(1) Example of Step of Preparing a Coarse-Pulverized Powder of an Alloy for the Sintered R-T-B Based Magnet>

The step of preparing a coarse-pulverized powder of an alloy for the sintered R-T-B based magnet in this embodiment includes a step of preparing an alloy for the sintered R-T-B based magnet and a step of coarsely pulverizing the alloy by, for example, a hydrogen pulverization method or the like.

Hereinafter, an example of method for producing the alloy for the sintered R-T-B based magnet will be described.

First, a metal material or an alloy adjusted in advance to have the above-described composition is melted, and the melted metal material or alloy is put into a casting mold by an ingot casting method. As a result, an alloy ingot may be obtained. Alternatively, a quenching method represented by a strip casting method may be used, by which the melted metal material or alloy is quenched by being in contact with a single roll, a twin roll, a rotary disc, a rotary cylindrical casting mold or the like to produce a flake-like alloy.

In an embodiment of the present disclosure, a material produced by either the ingot method or the quenching method is usable. It is preferred that the material is produced by the quenching method such as the strip casting method or the like. The alloy produced by the quenching method usually has a thickness in the range of 0.03 mm to 1 mm, and is flake-like. The melted alloy starts solidifying from a surface thereof that is in contact with a cooling roll (roll contact surface), and a crystal grows like a column in a thickness direction from the roll contact surface. The quenched alloy has been cooled in a shorter time period than an alloy (alloy ingot) produced by the conventional ingot casting method (mold casting method), and therefore, has a finer tissue and a shorter crystal grain size. The R-rich phase largely expands in the grain boundaries. Therefore, the quenching method is highly effective in dispersing the R-rich phase. For this reason, the R-rich phase is easily broken at the grain boundaries by a hydrogen pulverization method. The quenched alloy may be hydrogen-pulverized, so that the hydrogen-pulverized powder (coarse-pulverized powder) has a size (average particle size) that is, for example, not longer than 1.0 mm, preferably not shorter than 10 μm and not longer than 500 μm, and in addition, the alloy is embrittled. Thus, a fine-pulverized powder may be easily formed in the next step. The average particle size (d50) in the present disclosure may be measured by an airflow-dispersion laser diffraction method (conforming to JIS Z 8825:2013). That is, in this specification, the average particle size is the particle diameter (median diameter) at which the added particle size distribution (volume-based) from the side of the shorter particle diameter is 50%.

### <(2) Example of Step of Obtaining a Fine-Pulverized Powder>

In the step of obtaining a fine-pulverized powder in this embodiment, for example, the coarse-pulverized powder is provided to a jet mill device including a pulverization chamber filled with inert gas and is pulverized, and thus a fine-pulverized powder is obtained. In this step, for example, a fine-pulverized powder (R-T-B based alloy powder) having an average particle size of that is, for example, not shorter than 2.0 μm and not longer than 8.0 μm may be obtained. The step of obtaining such a fine-pulverized powder may be performed by use of, for example, a jet mill pulverization system.

As a result of steps after the fine pulverization (mainly, the step of producing a sintered body of the above-described fine-pulverized powder), the content of oxygen in the sintered R-T-B based magnet is increased preferably by a level that is not lower than 50 ppm and not higher than 300 ppm, and more preferably a level that is not lower than 50 ppm and not higher than 200 ppm. In order to achieve such an increase, it is preferred to perform magnetic field press by a wet press or in an inert gas atmosphere, and to sinter the obtained compact. The average particle size of the fine-pulverized powder in the step of obtaining the fine-pulverized powder is preferably not shorter than 2.0 μm and not longer than 5.0 μm, and more preferably not shorter than 2.5 μm and not longer than 4.0 μm. The average particle size may be shortened, so that the magnetic characteristics are improved. In the meantime, in the case where the average particle size is made excessively short, the productivity is declined.

### <(3) Example of Step of Producing a Compact of the Fine-Pulverized Powder>

Generally in a step of producing a compact, the magnetic field press, by which the powder is put into a mold, a magnetic field is provided from outside and press is performed, is adopted. In the step of producing the compact, it is preferred that the magnetic field press is performed in an inert gas atmosphere or by a wet press to produce a compact, from the point of view of suppressing oxidization. In the case where, in particular, the wet press is used, surfaces of grains that form the compact are covered with a dispersant such as oil or the like and thus are suppressed from being in contact with oxygen or water vapor in the air. Therefore, the grains may be prevented or suppressed from being oxidized by the air before, during, or after the pressing step.

In the case where the magnetic field wet press is performed, a slurry of the fine-pulverized powder mixed with a dispersion medium is prepared, and is supplied to a cavity of a mold of a wet press device to be pressed in a magnetic field. Thus, the compact is obtained.

### <(4) Example of the Step of Sintering>

Next, the compact is sintered to obtain a sintered body. The compact is sintered at a temperature in the range that is, for example, not lower than 900° C. and not higher than 1100° C. There is no specific limitation on the contents of the sintering, and the step of sintering may be performed by a known method. The sintering step in this embodiment may be performed in vacuum, or in inert gas such as helium, argon or the like. It is preferred to further perform heat treatment after the sintering. The heat treatment may improve the magnetic characteristics. The heat treatment conditions such as the heat-treatment temperature, the heat-treatment time period and the like may be known conditions.

The sintered R-T-B based magnet obtained in this manner is processed with a grinding and polishing step. a surface treatment step and a magnetization step as necessary, and thus a final sintered R-T-B based magnet is completed.

Various elements may be diffused into the interior of a sintered R-T-B based magnet produced by the above-described steps from a surface thereof, so that the magnetic characteristics are improved. In this case, the sintered body before the diffusion may be referred to as a “sintered R-T-B based magnet material”.

The sintered R-T-B based magnet material may be formed from one type of raw material alloy (single raw material alloy) or by a method of mixing two or more types of raw material alloys (blend method). The obtained sintered R-T-B based magnet material may be subjected to a known mechanical process such as cutting, shaving or the like as necessary, and then may be subjected to a first heat treatment and a second heat treatment described below.

In this embodiment, a metal material, an alloy, a compound or the like containing at least one of Nd and Pr may be diffused into the interior of the sintered R-T-B based magnet material obtained by the above-described method from a surface thereof. As a result of such diffusion, the sintered R-T-B based magnet includes a portion where at least one of a concentration of Nd and a concentration of Pr gradually decreases from the surface of the magnet toward the interior thereof. Similarly, a metal material, an alloy, a compound or the like containing at least one of Tb and Dy may be diffused into the interior of the magnet from a surface thereof. As a result of such diffusion, the sintered R-T-B based magnet includes a portion where at least one of a concentration of Tb and a concentration of Dy gradually decreases from the surface of the magnet toward the interior thereof.

### Step of Preparing a Diffusion Source

First, a composition of a diffusion source in the step of preparing the diffusion source will be described.

The diffusion source may contain a heavy rare-earth element such as Dy, Tb, Gd, Ho or the like. Preferably, the diffusion source contains at least one of Nd and Pr as the rare-earth element with no exception. It is preferred that Pr is contained at a content that is not lower than 50 mass % of the rare-earth element. A reason for this is that at this content of Pr, higher H_{cJ} may be obtained while the content of a heavy rare-earth element is suppressed. According to the present disclosure, sufficiently high H_{cJ} may be obtained without using a large amount of heavy rare-earth element. Therefore, the content of a heavy rare-earth element is preferably not higher than 10 mass %, and more preferably not higher than 5 mass %, with respect to the entirety of the diffusion source. Still more preferably, no heavy rare-earth element is contained (the content of the heavy rare-earth element is substantially 0 mass %). Even in the case where the diffusion source contains a heavy rare-earth element, it is preferred that Pr is contained at a content not lower than 50 mass % of the rare-earth element, and it is more preferred that Pr is the only rare-earth element except for the heavy rare-earth element (unavoidable impurities may be contained).

In the case where at least one of Nd and Pr is contained as a rare-earth element with no exception, the content of such a rare-earth element is preferably, for example, not lower than 35 mass % and lower than 85 mass % with respect to the entirety of the diffusion source. In the case where the content of the rare-earth element is lower than 35 mass %, it is possible that diffusion does not proceed sufficiently in the first heat treatment described below. By contrast, in the case where the content of the rare-earth element is not lower than 85 mass %, the alloy powder in the diffusion source becomes very active during the production process. As a result, the alloy powder may possibly be significantly oxidized or ignited.

The diffusion source may contain, in addition to the above-described elements, Ga, Fe, Cu, Co, Al, Ag, Zn, Si. In, Sn, Zr, Nb, Ti, Ni, Hf, Ta, W, Ge, Mo, V, Y, La, Ce, Sm, Ca, Mg, Mn, Cr, H, F, P, S, Cl, O, N, C or the like.

The diffusion source may be prepared by a raw material alloy production method adopted for a general production method represented by general production methods used for producing sintered R-T-B based magnets; for example, by a die-cast method, a strip cast method, a single roll rapid quenching method (melt spinning method), an atomization method or the like. The diffusion source may be prepared by pulverizing an alloy obtained as described above by a known pulverization method using a pin mill or the like. In order to improve the ease of pulverization of the alloy obtained as described above, the alloy may be heat-treated at a temperature that is not higher than 700° C. in a hydrogen atmosphere to have hydrogen incorporated thereto before being pulverized.

Step of Diffusing an Element Contained in the Diffusion Source into the Interior of the Sintered R-T-B Based Magnet Material from a Surface Thereof

The sintered R-T-B based magnet material is heat-treated at a temperature that is not lower than 700° C. and not higher than 1100° C. in vacuum or in an inert gas atmosphere to diffuse an element contained in the diffusion source into the interior of the sintered R-T-B based magnet material from a surface thereof. In the present disclosure, this heat treatment is referred to as a first heat treatment. In the case where the heat-treatment temperature for diffusion is lower than 700° C., the diffusion is insufficient, and it is possible that high H_{cJ} is not obtained. By contrast, in the case where the heat-treatment temperature for diffusion exceeds 1100° C., abnormal grain growth of the main phase occurs, and it is possible that the H_{cJ} is decreased. The heat-treatment temperature for diffusion is preferably not lower than 800° C. and not higher than 1000° C. A reason for this is that at such a temperature, higher H_{cJ} may be obtained. Regarding the heat-treatment time period, an appropriate value is set in accordance with, for example, the composition or the size of the sintered body material or the diffusion source, or the heat-treatment temperature. The heat-treatment time period is preferably not shorter than 5 minutes and not longer than 30 hours, more preferably not shorter than 10 minutes and not longer than 25 hours, and still more preferably not shorter than 30 minutes and not longer than 20 hours. It is preferred that the diffusion source is prepared so as to be contained at a content that is not lower than 1 mass % and not higher than 30 mass % with respect to the weight of the sintered body material. In the case where the content of the diffusion source is lower than 1 mass % with respect to the weight of the sintered body material, it is possible that the H_{cJ} is decreased. By contrast, in the case where the content of the diffusion source exceeds 30 mass %, it is possible that the Bᵣ is decreased.

The heat treatment for diffusion may be performed by a known heat-treatment method. For example, a surface of the sintered R-T-B based magnet material may be covered with a powder layer of the diffusion source to perform the first heat treatment. For example, the first heat treatment may be performed after the surface of the sintered R-T-B based magnet material is coated with the diffusion source by a sputtering method. At this point, the diffusion source used to coat the surface may have a multi-layer structure including a metal or alloy layer not containing a rare-earth element and a metal or alloy layer containing a rare-earth element. For example, a slurry containing the diffusion source dispersed in a dispersion medium may be applied to the surface of the sintered R-T-B based magnet material, and then the dispersion medium may be evaporated to put the diffusion source and the sintered R-T-B based magnet material into contact with each other. Examples of the dispersion medium may be alcohol (ethanol, etc.), NMP (N-methylpyrrolidone), aldehyde, and ketone. The sintered R-T-B based magnet material processed with the first heat treatment may be subjected to a known mechanical process such as cutting, shaving or the like.

The sintered R-T-B based magnet material processed with the heat treatment for diffusion may be heat-treated at a temperature that is not lower than 450° C. and not higher than 600° C. in vacuum or in an inert gas atmosphere. In the present disclosure, this heat treatment is referred to as a second heat treatment. As a result of the second heat treatment, high Bᵣ and high H_{cJ} may be obtained. The temperature of the second heat treatment is not lower than 450° C. and not higher than 600° C., so that generation of an R₆T₁₃Ga phase proceeds (in the case where the obtained sintered magnet contains Ga). The second heat treatment is preferably performed at a temperature that is not lower than 480° C. and not higher than 560° C. With such a temperature, higher H_{cJ} may be obtained. Regarding the heat-treatment time period, an appropriate value may be set in accordance with, for example, the composition or the size of the sintered body material, or the heat-treatment temperature. The heat-treatment time period is preferably not shorter than 5 minutes and not longer than 20 hours, more preferably not shorter than 10 minutes and not longer than 15 hours, and still more preferably not shorter than 30 minutes and not longer than 10 hours.

Whether or not a sintered R-T-B based magnet in which three classes that are the lowest class, the second lowest class and the third lowest class have a total frequency that is not higher than 12% of the frequency of all the classes (the frequency at which the grain boundary width is 0.03 μm is not higher than 12% of the frequency of all the classes) is produced is determined by the combination of the composition of the magnet, the sintering temperature and the heat-treatment temperature. In addition, in the case where at least one of Nd and Pr is diffused into the interior of the sintered body material from a surface thereof, whether or not the sintered R-T-B based magnet is produced is determined by the combination of the composition of the diffusion source, the amount of diffusion source, and the heat-treatment temperature for diffusion. These production conditions are studied by experiments or the like, and as a result, a sintered R-T-B based magnet in which the three classes that are the lowest class, the second lowest class and the third lowest class have a total frequency that is not higher than 12% of the frequency of all the classes (the frequency at which the grain boundary width is not longer than 0.03 μm is not higher than 12% of the frequency of all the classes) may be produced. In experiment examples described below, conditions such as the heat-treatment temperature, the composition of the diffusion source and the amount of diffusion after the sintering are adjusted.

### Experiment Examples

Raw materials of each of elements were weighed such that the sintered R-T-B based magnet materials would have the compositions shown in Table 1, and alloys were produced by a strip casting method. The obtained alloys were each coarse-pulverized by a hydrogen pulverization method to obtain a coarse-pulverized powder. Next, zinc stearate as a lubricant was incorporated to, and mixed with, the obtained coarse-pulverized powder at a content of 0.04 mass % with respect to 100 mass % of the coarse-pulverized powder. The obtained mixture was dry-pulverized in a nitrogen airflow by use of a jet mill device.

Zinc stearate as a lubricant was incorporated to, and mixed with, the obtained fine-pulverized powder at a content of 0.05 mass % with respect to 100 mass % of the fine-pulverized powder. Then, the obtained substance was pressed in a magnetic field to obtain a compact. As a pressing apparatus, a so-called orthogonal magnetic field pressing apparatus (transverse magnetic field pressing apparatus) was used, by which the direction of magnetic field application and the pressurizing direction were orthogonal to each other. The obtained compact was sintered at a temperature not lower than 1060° C. and not higher than 1090° C. (a temperature at which the compact would be sufficiently densified by sintering was selected for each sample) for 4 hours in vacuum to obtain a sintered R-T-B based body. The obtained sintered R-T-B based magnet material had a density of 7.5 Mg/m³. The components of the sintered R-T-B based magnet materials thus obtained are shown in Table 1. The components in Table 1 were measured by an inductively coupled plasma optical emission spectrometry (ICP-OES). This is applicable to the diffusion source described below.

Raw materials of each of elements were weighed such that the diffusion source would generally have the compositions shown in Table 1, and the raw materials were melted to obtain ribbon-like or flake-like alloys by a single roll rapid quenching method (melt spinning method). Each of the obtained alloys was pulverized in an argon atmosphere by use of a mortar and was caused to pass a sieve having perforations of 425 μm to obtain an R-M alloy. The compositions of the R-M alloys thus obtained are shown in Table 1.

Each of the obtained sintered R-T-B based magnet materials was cut and ground into a cube of 7.4 mm×7.4 mm×7.4 mm. Next, the diffusion source was scattered onto the entire surface of the sintered R-T-B based magnet material at an amount shown in Table 1. In the step of diffusing the diffusion source, the sintered R-T-B based magnet material with the diffusion source was subjected to the first heat treatment at a diffusion temperature shown in Table 1 for 4 hours in a low pressure argon atmosphere controlled to be 50 Pa, and then was cooled down to room temperature. The sintered R-T-B based magnet already processed with the first heat treatment was subjected to the second heat treatment at 500° C. as shown in Table 2 for 1 hour in a low pressure argon atmosphere controlled to be 50 Pa, and then was cooled down to room temperature to produce a sintered R-T-B based magnet. The obtained sintered R-T-B based magnet was subjected to a mechanical process into a size of 7 mm×7 mm×7 mm. The magnetic characteristic (H_{cJ}) was measured by a BH tracer. The measurement results are shown in Table 1.

In some of the examples, the same sintered R-T-B based magnet materials as those in comparative examples 1 through 4 were used. However, in these examples, production conditions such as the composition of the sintered R-T-B based magnet material, the composition of the diffusion source, the amount of the diffusion source, the first heat treatment, the second treatment and the like are changed from those in the comparative examples.

TABLE 1

| | | | | | | | | | | | | | | | | AMOUNT OF | | |
|---|---|---|---|---|---|---|---|---|---|---|---|---|---|---|---|---|---|---|
| | | | | | | | | | | | | | | | | DIFFUSION | | |
| | | | | | | | | | | | | | INTENDED | | | SOURCE | 1ST | 2ND |
| | | MAG- | | | | | | | | | | | COMOPSITION | | | (WITH | HEAT | HEAT |
| | | NET | INTENDED COMPOSITION OF | | | | | | | | | | OF DIFFUSION | | | RESPECT | TREAT- | TREAT- |
| | | MATE- | SINTERED R-T-B BASED MAGNET | | | | | | | | | | SOUCE | | | TO MASS | MENT | MENT |
| | HcJ | RIAL | MATERIAL (MASS %) | | | | | | | | | | (MASS %) | | | % OF | TEMP. | TEMP. |
| | (kA/m) | NO. | Nd | Pr | Co | Al | Zr | Cu | C | Fe | B | Ga | Pr | Cu | Ga | MATERIAL) | (° C.) | (° C.) |
| COM- | 1207 | A | 22.8 | 5.4 | 0.05 | 0.05 | 0.1 | 0.1 | 0.04 | bal | 0.88 | 0 | 90 | 10 | 0 | 3.5 | 900 | 500 |
| PAR- | | | | | | | | | | | | | | | | | | |
| ATIVE | | | | | | | | | | | | | | | | | | |
| EX. 1 | | | | | | | | | | | | | | | | | | |
| COM- | 1261 | E | 22.8 | 5.4 | 0.05 | 0.05 | 0.1 | 0.1 | 0.04 | bal | 0.9 | 0.5 | 90 | 3 | 7 | 2.5 | 900 | 500 |
| PAR- | | | | | | | | | | | | | | | | | | |
| ATIVE | | | | | | | | | | | | | | | | | | |
| EX. 2 | | | | | | | | | | | | | | | | | | |
| COM- | 1366 | E | 22.8 | 5.4 | 0.05 | 0.05 | 0.1 | 0.1 | 0.04 | bal | 0.9 | 0.5 | 90 | 10 | 0 | 2.5 | 900 | 500 |
| PAR- | | | | | | | | | | | | | | | | | | |
| ATIVE | | | | | | | | | | | | | | | | | | |
| EX. 3 | | | | | | | | | | | | | | | | | | |
| COM- | 1373 | C | 22.8 | 5.4 | 0.05 | 0.05 | 0.1 | 0.1 | 0.04 | bal | 0.88 | 0.5 | 90 | 10 | 0 | 3.0 | 700 | NO |
| PAR- | | | | | | | | | | | | | | | | | | AGING |
| ATIVE | | | | | | | | | | | | | | | | | | TREAT- |
| EX. 4 | | | | | | | | | | | | | | | | | | MENT |
| EX. 1 | 1498 | B | 22.8 | 5.4 | 0.05 | 0.05 | 0.1 | 0.1 | 0.04 | bal | 0.88 | 0.1 | 90 | 10 | 0 | 3.5 | 900 | 500 |
| EX. 2 | 1608 | C | 22.8 | 5.4 | 0.05 | 0.05 | 0.1 | 0.1 | 0.04 | bal | 0.88 | 0.5 | 90 | 3 | 7 | 2.5 | 900 | 500 |
| EX. 3 | 1636 | C | 22.8 | 5.4 | 0.05 | 0.05 | 0.1 | 0.1 | 0.04 | bal | 0.88 | 0.5 | 90 | 10 | 0 | 3.0 | 700 | 500 |
| EX. 4 | 1636 | E | 22.8 | 5.4 | 0.05 | 0.05 | 0.1 | 0.1 | 0.04 | bal | 0.9 | 0.5 | 90 | 10 | 0 | 3.5 | 900 | 500 |
| EX. 5 | 1653 | E | 22.8 | 5.4 | 0.05 | 0.05 | 0.1 | 0.1 | 0.04 | bal | 0.9 | 0.5 | 90 | 3 | 7 | 3.5 | 900 | 500 |
| EX. 6 | 1659 | E | 22.8 | 5.4 | 0.05 | 0.05 | 0.1 | 0.1 | 0.04 | bal | 0.9 | 0.5 | 90 | 10 | 0 | 3.0 | 900 | 500 |
| EX. 7 | 1681 | A | 22.8 | 5.4 | 0.05 | 0.05 | 0.1 | 0.1 | 0.04 | bal | 0.88 | 0 | 90 | 3 | 7 | 3.5 | 900 | 500 |
| EX. 8 | 1704 | C | 22.8 | 5.4 | 0.05 | 0.05 | 0.1 | 0.1 | 0.04 | bal | 0.88 | 0.5 | 90 | 10 | 0 | 3.0 | 900 | 500 |
| EX. 9 | 1715 | B | 22.8 | 5.4 | 0.05 | 0.05 | 0.1 | 0.1 | 0.04 | bal | 0.88 | 0.1 | 90 | 3 | 7 | 3.5 | 900 | 500 |
| EX. 10 | 1727 | C | 22.8 | 5.4 | 0.05 | 0.05 | 0.1 | 0.1 | 0.04 | bal | 0.88 | 0.5 | 90 | 3 | 7 | 3.5 | 900 | 500 |
| EX. 11 | 1735 | C | 22.8 | 5.4 | 0.05 | 0.05 | 0.1 | 0.1 | 0.04 | bal | 0.88 | 0.5 | 90 | 10 | 0 | 2.5 | 900 | 500 |
| EX. 12 | 1759 | D | 22.8 | 5.4 | 0.05 | 0.05 | 0.1 | 0.1 | 0.04 | bal | 0.88 | 1 | 90 | 10 | 0 | 3.0 | 900 | 500 |
| EX. 13 | 1780 | C | 22.8 | 5.4 | 0.05 | 0.05 | 0.1 | 0.1 | 0.04 | bal | 0.88 | 0.5 | 90 | 10 | 0 | 3.0 | 900 | 480 |
| EX. 14 | 1788 | C | 22.8 | 5.4 | 0.05 | 0.05 | 0.1 | 0.1 | 0.04 | bal | 0.88 | 0.5 | 90 | 10 | 0 | 3.0 | 900 | 460 |
| EX. 15 | 1795 | C | 22.8 | 5.4 | 0.05 | 0.05 | 0.1 | 0.1 | 0.04 | bal | 0.88 | 0.5 | 90 | 10 | 0 | 3.0 | 900 | 500 |
| EX. 16 | 1796 | C | 22.8 | 5.4 | 0.05 | 0.05 | 0.1 | 0.1 | 0.04 | bal | 0.88 | 0.5 | 90 | 10 | 0 | 3.0 | 900 | 480 |
| EX. 17 | 1829 | C | 22.8 | 5.4 | 0.05 | 0.05 | 0.1 | 0.1 | 0.04 | bal | 0.88 | 0.5 | 90 | 10 | 0 | 3.5 | 900 | 500 |

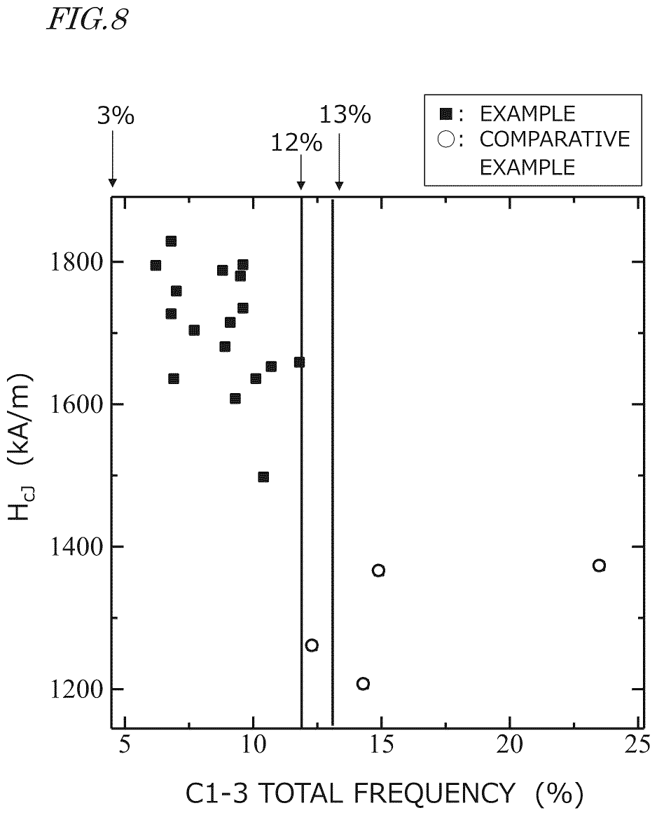

FIG. 8 is a graph showing the relationship between the C₁₋₃ total frequency and the H_{cJ} obtained from the examples and the comparative examples. Herein, the “C₁₋₃ total frequency” is the total frequency of three classes that are the lowest class, the second lowest class and the third lowest class in a frequency histogram of the grain boundary width measured from N-piece reference points included in the intergranular grain boundary that is present in a cross-section including, in a plane thereof, the alignment direction of the sintered R-T-B based magnet. Table 2 shows the relationship between the C₁₋₃ total frequency and the H_{cJ}.

The C₁₋₃ total frequency in each of the examples and the comparative examples was calculated by the above-described method. The cross-section used for the measurement was at a position (depth) of 0.1 mm from the surface of the sintered R-T-B based magnet. Five digital images were acquired from each one sintered R-T-B based magnet. A total area of 3300 μm² was acquired.

As clearly seen from FIG. 8 and Table 2, when the C₁₋₃ total frequency exceeds 12%, the H_{cJ} is lower than 1400 kA/m. According to the studies of the present inventors, it is preferred that the C₁₋₃ total frequency is not lower than 3% and not higher than 12% of the frequency of all the classes. Under the above-described measurement conditions for the grain boundary width, the C₁₋₃ total frequency being not higher than 12% corresponds to that the frequency at which the grain boundary width in the frequency histogram is not longer than 0.03 μm is not higher than 12% of the frequency of all the classes. The frequency at which the grain boundary width is not longer than 0.03 μm is preferably not lower than 3% and not higher than 12%.

TABLE 2

| | | TOTAL FREQUENCY (NUMBER-BASED, |
|---|---|---|
| | | %) OF THE LOWEST, 2ND LOWEST |
| | HcJ | AND 3RD LOWEST CLASSES (GRAIN |
| | (kA/m) | BOUNDARY WIDTH: 0.03 μm) |
| COMPARATIVE | 1207 | 14.3 |
| EX. 1 | | |
| COMPARATIVE | 1261 | 12.3 |
| EX. 2 | | |
| COMPARATIVE | 1366 | 14.9 |
| EX. 3 | | |
| COMPARATIVE | 1373 | 23.5 |
| EX. 4 | | |
| EX. 1 | 1498 | 10.4 |
| EX. 2 | 1608 | 9.3 |
| EX. 3 | 1636 | 6.9 |
| EX. 4 | 1636 | 10.1 |
| EX. 5 | 1653 | 10.7 |
| EX. 6 | 1659 | 11.8 |
| EX. 7 | 1681 | 8.9 |
| EX. 8 | 1704 | 7.7 |
| EX. 9 | 1715 | 9.1 |
| EX. 10 | 1727 | 6.8 |
| EX. 11 | 1735 | 9.6 |
| EX. 12 | 1759 | 7.0 |
| EX. 13 | 1780 | 9.5 |
| EX. 14 | 1788 | 8.8 |
| EX. 15 | 1795 | 6.2 |
| EX. 16 | 1796 | 9.6 |
| EX. 17 | 1829 | 6.8 |

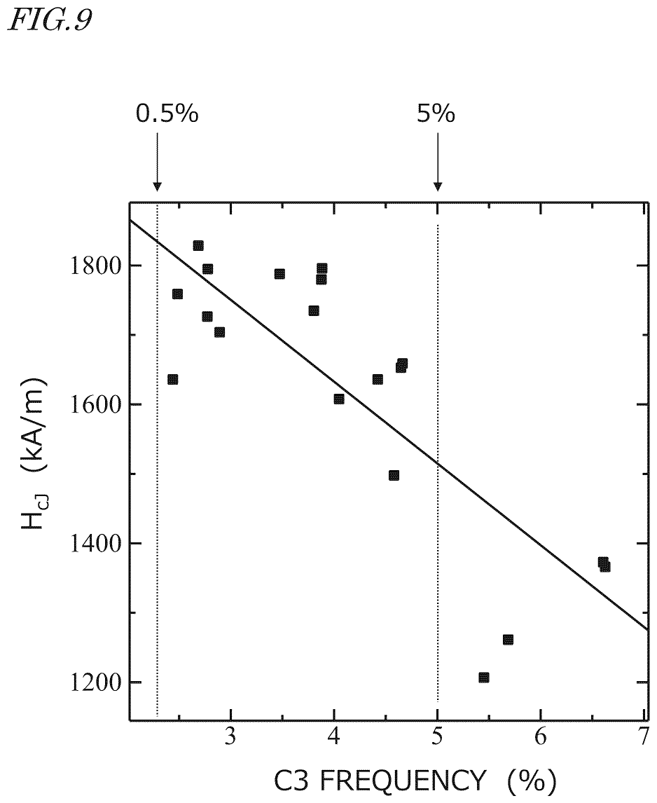

FIG. 9 is a graph showing the relationship between the frequency of class C3 (C3 frequency) (in C3, the grain boundary width is in the range that is not shorter than 0.02 μm and not longer than 0.03 μm) and the H_{cJ}. As clearly seen from FIG. 9, as the C3 frequency becomes lower, the H_{cJ} becomes higher. It is preferred that the C3 frequency is not higher than 5% (specifically, not lower than 0.5% and not higher than 5%).

### INDUSTRIAL APPLICABILITY

The sintered R-T-B based magnet according to the present disclosure is usable as permanent magnets used in various applications including various types of motors such as voice coil motors (VCMs) for hard disc drives, motors of electric vehicles (EV, HV, PHV), motors of industrial equipment and the like, and consumer electronics.

1. A sintered R-T-B based magnet (R is at least one of rare-earth elements and contains at least one of Nd and Pr with no exception, T is Fe or Fe and Co, and B is boron), comprising:
a main phase formed of a plurality of R₂T₁₄B compound grains; and
a grain boundary phase located between the plurality of R₂T₁₄B compound grains and including an intergranular grain boundary and a grain boundary triple junction,
wherein in a frequency histogram of a grain boundary width measured from N-piece reference points included in the intergranular grain boundary that is located in a cross-section including, in a plane thereof, an alignment direction of the sintered R-T-B based magnet, in the case where widths of classes are determined such that the sixth class counted from the lowest class shows the mode, three classes that are the lowest class, the second lowest class and the third lowest class have a total frequency that is not higher than 12% of the frequency of all classes.

2. A sintered R-T-B based magnet (R is at least one of rare-earth elements and contains at least one of Nd and Pr with no exception, T is Fe or Fe and Co, and B is boron), comprising:
a main phase formed of a plurality of R₂T₁₄B compound grains; and
a grain boundary phase located between the plurality of R₂T₁₄B compound grains and including an intergranular grain boundary and a grain boundary triple junction,
wherein in a frequency histogram of a grain boundary width measured from N-piece reference points included in the intergranular grain boundary that is located in a cross-section including, in a plane thereof, an alignment direction of the sintered R-T-B based magnet, the frequency at which the grain boundary width is not longer than 0.03 μm is not higher than 12% of the frequency of all classes.

3. The sintered R-T-B based magnet of claim 1, wherein the cross-section is at a position having a distance from a surface of the sintered R-T-B based magnet that is not shorter than 0.05 mm and not longer than 0.15 mm.

4. The sintered R-T-B based magnet of claim 1, wherein where T has a composition ratio of [T] represented with mass % and B has a composition ratio of [B] represented with mass %, the expression that [T]/55.85>14×[B]/10.8 holds.

5. The sintered R-T-B based magnet of claim 1, wherein the three classes that are the lowest class, the second lowest class and the third lowest class in the frequency histogram have a total frequency that is not higher than 10% of the frequency of all the classes.

6. The sintered R-T-B based magnet of claim 1, wherein the three classes that are the lowest class, the second lowest class and the third lowest class in the frequency histogram have a total frequency that is not lower than 3% and not higher than 12% of the frequency of all the classes.

7. The sintered R-T-B based magnet of claim 1, wherein R in the sintered R-T-B based magnet has a composition ratio that is not higher than 31 mass %.

8. The sintered R-T-B based magnet of claim 1, wherein Dy and Tb in the sintered R-T-B based magnet have a total composition ratio that is not higher than 0.5 mass % (including 0 mass %).

9. The sintered R-T-B based magnet of claim 1, wherein the sintered R-T-B based magnet includes a portion where a concentration of R gradually decreases from a surface of the magnet toward an interior thereof.

10. The sintered R-T-B based magnet of claim 1, wherein the frequency at which the grain boundary width in the frequency histogram is not longer than 0.03 μm is not higher than 12% of the frequency of all the classes.

11. The sintered R-T-B based magnet of claim 2, wherein the frequency at which the grain boundary width in the frequency histogram is in a range that is not shorter than 0.02 μm and not longer than 0.03 μm is not higher than 5% of the frequency of all the classes.

12. The sintered R-T-B based magnet of claim 2, wherein the frequency at which the grain boundary width in the frequency histogram is in a range that is not shorter than 0.02 μm and not longer than 0.03 μm is not lower than 0.5% and not higher than 5% of the frequency of all the classes.

13. The sintered R-T-B based magnet of claim 2, wherein the frequency at which the grain boundary width in the frequency histogram is not longer than 0.03 μm is not lower than 3% and not higher than 12% of the frequency of all classes.

14. The sintered R-T-B based magnet of claim 2, wherein in the case where widths of classes are determined such that the sixth class counted from the lowest class shows the mode in the frequency histogram, three classes that are the lowest class, the second lowest class and the third lowest class have a total frequency that is not higher than 12% of the frequency of all the classes.

15. The sintered R-T-B based magnet of claim 2, wherein the cross-section is at a position having a distance from a surface of the sintered R-T-B based magnet that is not shorter than 0.05 mm and not longer than 0.15 mm.

16. The sintered R-T-B based magnet of claim 2, wherein where T has a composition ratio of [T] represented with mass % and B has a composition ratio of [B] represented with mass %, the expression that [T]/55.85>14×[B]/10.8 holds.

17. The sintered R-T-B based magnet of claim 2, wherein R in the sintered R-T-B based magnet has a composition ratio that is not higher than 31 mass %.

18. The sintered R-T-B based magnet of claim 2, wherein Dy and Tb in the sintered R-T-B based magnet have a total composition ratio that is not higher than 0.5 mass % (including 0 mass %).

19. The sintered R-T-B based magnet of claim 2, wherein the sintered R-T-B based magnet includes a portion where a concentration of R gradually decreases from a surface of the magnet toward an interior thereof.
